(19) United States
(12) Patent Application Publication
(10) Pub. No.: US 2014/0060242 A1
(43) Pub. Date: Mar. 6, 2014

(54) Bicycle Pedal Adaptor for Use on Multi Sided Clipless Bicycle Pedals

(71) Applicant: Pub Pedals, Inc., Canmore (CA)

(72) Inventors: Jeffrey Thom, Canmore (CA); Steve Fedyna, Canmore (CA)

(73) Assignee: Pub Pedals, Inc., Canmore (CA)

(21) Appl. No.: 14/010,504

(22) Filed: Aug. 26, 2013

Related U.S. Application Data
(60) Provisional application No. 61/696,160, filed on Sep. 1, 2012.

(51) Int. Cl. B62M 3/08

(52) U.S. Cl. CPC B62M 3/086
USPC 74/594.4; 29/401.1

(57) ABSTRACT

The invention is a device for adapting a clipless bicycle pedal into a standard bicycle pedal. The clipless bicycle pedal fits into a shaped recess in the body of the pedal adaptor. The shaped recess extends along the longitudinal axis of the body of the pedal adaptor and is shaped such that the clipless bicycle pedal is compressed within the shaped recess, causing a frictional force to retain the pedal adaptor on the clipless bicycle pedal during use. The body of the pedal adaptor is formed from a thermoplastic or a fiberglass reinforced thermoplastic.

### PRIORITY OF INVENTION

This non-provisional application claims the benefit of priority under 35 U.S.C. §119(e) to U.S. Provisional Patent Application Ser. No. 61/696,160 entitled, “Bicycle Pedal Adaptor for Use on Multi Sided Clipless Bicycle Pedals”, filed on Sep. 1, 2012, which is hereby incorporated by reference.

### TECHNICAL FIELD

This invention relates to pedals for bicycles and more specifically to an adaptor for use on a clipless bicycle pedal for the purpose of adapting the bicycle pedal from one requiring special cleats to a bicycle pedal for use with standard shoes.

### BACKGROUND OF THE INVENTION

U.S. Pat. No. 6,205,885 (Hermansen et al.) discloses a clipless bicycle pedal. The clipless bicycle pedal is designed to be used in conjunction with specialized cycling shoes. A cleat is attached to a bottom of a cycling shoe. The clipless bicycle pedal connects to the cleat of the cycling shoe when a rider steps onto the pedal. The cleat and the clipless pedal establish a secure connection so that a rider's shoes do not slip off of the pedals while cycling. This is useful when a rider is riding a bicycle on uneven terrain or during a race. The clipless bicycle pedal has four sides which can engage the cleat. The clipless bicycle pedal has a spring loaded latch mechanism. The latches engage the cleat on the rider's cycling shoe. The spring maintains a pressure that the latches apply to the cleat.

Clipless bicycle pedals are beneficial during rigorous exercise and outdoor riding. Clipless bicycle pedals are limiting however when a rider desires to ride in a casual manner without special cycling shoes with cleats. A clipless bicycle pedal does not fit with a normal shoe. A normal shoe requires more surface area than the latches provide. A normal shoe would not engage properly with the clipless bicycle pedal and would slip off.

In addition, a rider may experience pain or discomfort when attempting to ride on a bicycle with a clipless bicycle pedal. The clipless bicycle pedal has a smaller area of contact with a rider's foot than a standard bicycle pedal. As such the pounds per square inch exerted on a rider's foot is much higher with a clipless bicycle pedal. If a rider attempts to use the clipless bicycle pedal with a casual shoe, or a sandal, which is not constructed to receive such force, then the rider will experience pain and may even cause injury to the rider's foot. Thus, to engage in casual riding, a rider must either use a second bicycle or take the time to remove the clipless bicycle pedal and attach a standard bicycle pedal.

Other types of adaptors are known and available to solve this problem. EP 0516013 (Nagano, et al.) discloses an adaptor which engages the clipless bicycle pedal in the method that a cleat on a cycling shoe would engage the clipless bicycle pedal. This type of adaptor is limited though in that it only presents one side to a rider to engage with as a standard bicycle pedal. As the pedal may spin about its axis, the clipless bicycle pedal could be moved to the top position while the adaptor is moved to the bottom position. This would cause a nuisance to the rider as the rider would have to take time to spin the adaptor about the axis of the clipless bicycle pedal to present the adaptor in the correct position for utilization by the rider. In addition, adaptors of this type may not be easily used if the clipless bicycle pedal or the adaptor becomes damaged or distorted. The present invention presents a superior alternative to this type of adaptor in that the present invention presents two sides for a rider to engage with during casual riding and the present invention may be utilized even if the clipless bicycle pedal is slightly damaged or distorted.

Therefore, what is needed is an item and method allowing a rider to quickly adapt a clipless bicycle pedal into a standard bicycle pedal having two sides for a rider to utilize when riding.

### SUMMARY OF THE INVENTION

The invention is directed toward a pedal adaptor for use to adapt a clipless bicycle pedal having four arms into a standard bicycle pedal. The invention is a device for adapting a clipless bicycle pedal into a standard bicycle pedal comprising a body and a shaped recess in the body wherein the shaped recess extends along the longitudinal axis of the body and wherein the shaped recess is shaped to receive a clipless bicycle pedal having four sides designed to engage a cleat on a cycling shoe. Furthermore, the shaped recess may be in a butterfly shape. Furthermore, the shaped recess may measure 1.27 inches wide and 1.14 inches high at a maximum height. Optionally, in another embodiment, the body is shaped as a cubic rectangle measuring 3 inches wide by 3.57 inches long by 1.75 inches thick. The cubic rectangle has six substantially flat surfaces on the outside. The largest areas of the two opposing sides are intended for to be pedaling surfaces. The pedaling surfaces are intended for contact by the shoe of the rider.

In another embodiment of the invention, the pedaling surfaces of the body contain a plethora of crossmembers. Furthermore, the crossmembers on opposing pedaling surfaces are offset from one another. Additionally, the pedaling surfaces of the body may contain elongated grooves. Additionally the body may contain two elongated oval voids located on the edges of the body.

The body of the pedal adaptor may be formed from any type of material commonly used in consumer products. Preferably, the body is formed from a thermoplastic. Specifically the body may be formed from polypropelene. In another embodiment of the invention, the body is formed from a fiberglass reinforced thermoplastic. Specifically the fiberglass reinforced thermoplastic is fiberglass reinforced homopolymer polypropelene.

In another embodiment of the invention, the cubic rectangle shape of the body has rounded corners.

The invention is also directed toward a method of converting a clipless bicycle pedal into a standard bicycle pedal. The invention includes the method of adapting a clipless bicycle pedal to a standard bicycle pedal comprising compressing the arms of the clipless bicycle pedal, inserting the clipless bicycle pedal into a shaped recess of a pedal adaptor, and allowing the arms of the clipless bicycle pedal to exert a force against the inside of the shaped recess. In this method the pedal adaptor comprises a body and a shaped recess in the body. In another embodiment of the method, the shaped recess is butterfly shaped and measures 1.27 inches wide and 1.14 inches high at a maximum height. Furthermore, in this method, the body of the pedal adaptor is shaped as a cubic rectangle. The cubic rectangle measures 3 inches wide by 3.57 inches long by 1.75 inches thick. In a further embodiment of the method, the pedaling surfaces of the body contain a plethora of crossmembers. The crossmembers on opposing pedaling surfaces are offset from one another. In this method the body of the pedal adaptor may be formed from a thermoplastic. More specifically, the thermoplastic may be polypropelene. In another embodiment of the invention, the body of the pedal adaptor is formed from a fiberglass reinforced homopolymer polypropelene.

### BRIEF DESCRIPTION OF THE DRAWINGS

FIG. 1 is a perspective view of the pedal adaptor.

FIG. 2 is a side view of the pedal adaptor.

FIG. 3 is a top view of the pedal adaptor.

### DETAILED DESCRIPTION

Although the present invention will be described with reference to the exemplary embodiments shown in the drawings, it should be understood that the present invention can be embodied in many alternate forms or embodiments. In addition, any suitable size, shape or type of elements or materials could be used.

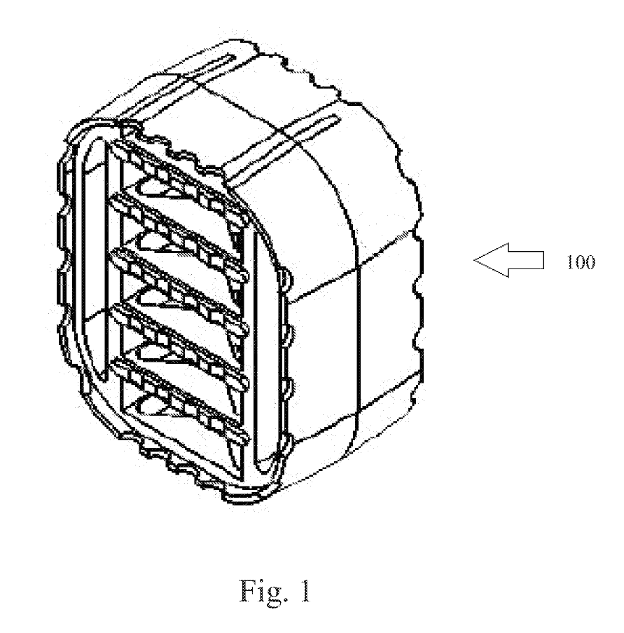

FIG. 1 displays a perspective view of the pedal adaptor 100. The pedal adaptor 100 is cuboid in shape. The cuboid is a rectangular cube.

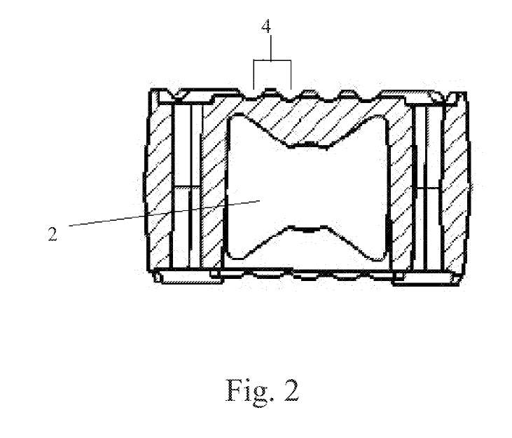

Referring to FIG. 2, the pedal adaptor 100 contains a shaped recess 2. The shaped recess extends predominantly through the length of the pedal adaptor 100. The shaped recess 2 is shaped to receive a clipless bicycle pedal. The shaped recess 2 is positioned along the longitudinal axis of the pedal adaptor 100. The shaped recess 2 is in a butterfly shape. The shaped recess 2 has a central circular area and wings extending to the sides of the central circular area. The arms of the clipless bicycle pedal slide into the wings of the shaped recess 2. The shaped recess 2 is structured so that the arms of a clipless bicycle pedal compress when the clipless bicycle pedal is inserted into the shaped recess 2. The compression of the arms of the clipless bicycle pedal causes the arms to exert a counter force on the edges of the wings of the shaped recess 2. The friction placed by the clipless bicycle pedal on the shaped recess 2 is sufficient to hold the pedal adaptor 100 onto the clipless bicycle pedal. The pedal adaptor 100 may only be removed if a greater force is exerted. The pedaling surface of the pedal adaptor 100 contains a plethora of grooves 4. The grooves 4 extend along the length of the pedal adaptor 100.

The grooves 4 permit an enhanced traction between the rider's shoes and the pedal adaptor 100 to prevent slippage during use.

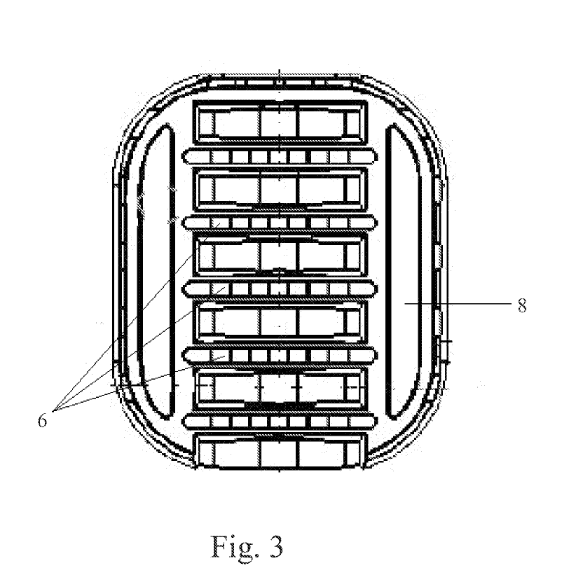

Referring to FIG. 3, the pedaling surface of the pedal adaptor 100 is shown. The pedaling surface of the pedal adaptor 100 contains a plethora of crossmembers 6. The crossmembers 6 extend along the width of the pedal adaptor 100. Between the crossmembers 6 there are voids to reduce the weight of the pedal adaptor 100. The voids between the crossmembers 6 extend toward the shaped recess 2. The crossmembers 6 of the opposing pedaling surfaces are offset from each other. In addition, the pedaling surface of the pedal adaptor 100 has two elongated ovals 8 which are void of material. The elongated ovals 8 extend the entire depth of the pedal adaptor 100. The void of material in the elongated ovals 8 is to reduce the weight of the pedal adaptor 100 and reduce the cost of production of the pedal adaptor 100.

1. A device for adapting a clipless bicycle pedal into a standard bicycle pedal comprising
A body
A shaped recess in said body
Wherein said shaped recess extends along the longitudinal axis of said body
Wherein said shaped recess is shaped to receive a clipless bicycle pedal having four sides designed to engage a cleat on a cycling shoe

2. The device as in claim 1 wherein said shaped recess is butterfly shaped

3. The device as in claim 2 wherein said shaped recess is 1.27 inches wide and 1.14 inches high at a maximum height

4. The device as in claim 3
Wherein said body is shaped as a cubic rectangle
Wherein said cubic rectangle measures 3 inches wide by 3.57 inches long by 1.75 inches thick

5. The device as in claim 4 wherein said pedaling surfaces of said body contains a plethora of crossmembers

6. The device as in claim 5 wherein said crossmembers on opposing pedaling surfaces are offset from one another

7. The device as in claim 6 wherein said pedaling surfaces of said body contain elongated grooves

8. The device as in claim 7 wherein said body contains two elongated oval voids located on the edges of said body

9. The device as in claim 6 wherein said body is formed from a thermoplastic

10. The device as in claim 9 wherein said thermoplastic is polypropelene

11. The device as in claim 6 wherein said body is formed from a fiberglass reinforced thermoplastic

12. The device as in claim 11 wherein said fiberglass reinforced thermoplastic is fiberglass reinforced homopolymer polypropelene

13. The device as in claim 8 wherein said cubic rectangle has rounded corners

14. The method of adapting a clipless bicycle pedal to a standard bicycle pedal comprising
Compressing the arms of said clipless bicycle pedal
Inserting the clipless bicycle pedal into a shaped recess of a pedal adaptor
Wherein said pedal adaptor comprises a body and a shaped recess in said body
Allowing the arms of said clipless bicycle pedal to exert a force against the inside of said shaped recess

15. The method as in claim 14
Wherein said shaped recess is butterfly shaped
Wherein said shaped recess is 1.27 inches wide and 1.14 inches high at a maximum height

16. The method as in claim 15
Wherein said body is shaped as a cubic rectangle
Wherein said cubic rectangle measures 3 inches wide by 3.57 inches long by 1.75 inches thick

17. The method as in claim 16
Wherein said pedaling surfaces of said body contains a plethora of crossmembers
Wherein said crossmembers on opposing pedaling surfaces are offset from one another

18. The method as in claim 17 wherein said body is formed from a thermoplastic

19. The method as in claim 18 wherein said thermoplastic is polypropelene

20. The method as in claim 17 wherein said body is formed from a fiberglass reinforced homopolymer polypropelene
